(19) United States
(12) Patent Application Publication
(10) Pub. No.: US 2024/0351849 A1
(43) Pub. Date: Oct. 24, 2024

(54) FUEL FUNNEL WITH AUXILIARY RESERVOIR

(71) Applicant: Andrew Kaluza, Bloomington, MN (US)

(72) Inventor: Andrew Kaluza, Bloomington, MN (US)

(21) Appl. No.: 18/136,606

(22) Filed: Apr. 19, 2023

(51) Int. Cl. B67C 11/02

(52) U.S. Cl. CPC B67C 11/02; B67C 2011/20; B67C 2011/30

(57) ABSTRACT

A fuel reservoir apparatus for facilitating filling an electric generator with fuel and retaining auxiliary fuel includes a container comprising a perimeter wall which bounds a chamber for retaining the auxiliary fuel. The container has an outlet to the chamber which is positioned at a bottom end thereof and an inlet to the chamber which is positioned at a top end thereof. A connector is coupled to the container and is configured to fluidly couple the chamber to a tank of an electric generator through the outlet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fuel filling apparatuses and more particularly pertains to a new fuel filling apparatus for facilitating filling an electric generator with fuel and retaining auxiliary fuel.

### (2) Description of Related Art Including Information Disclosed Under 37 CFR 1.97 and 1.98

The prior art discloses myriad fuel filling apparatuses which funnel fuel into a tank. However, the prior art does not describe such an apparatus which attaches to an electric generator to facilitate filling a tank of the electric generator with fuel and which retains auxiliary fuel.

### BRIEF SUMMARY OF THE INVENTION

An embodiment of the disclosure meets the needs presented above by generally comprising a container comprising a perimeter wall which bounds a chamber for retaining the auxiliary fuel. The container has an outlet to the chamber which is positioned at a bottom end thereof and an inlet to the chamber which is positioned at a top end thereof. A connector is coupled to the container and is configured to fluidly couple the chamber to a tank of an electric generator through the outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front perspective view of a fuel reservoir apparatus according to an embodiment of the disclosure.

FIG. 2 is a bottom front perspective view of an embodiment of the disclosure.

FIG. 3 is a side view of an embodiment of the disclosure.

FIG. 4 is a top view of an embodiment of the disclosure.

FIG. 5 is a cross-section view of an embodiment of the disclosure taken from Arrows 5-5.

FIG. 6 is an in-use view of an embodiment of the disclosure.

### DETAILED DESCRIPTION OF THE INVENTION

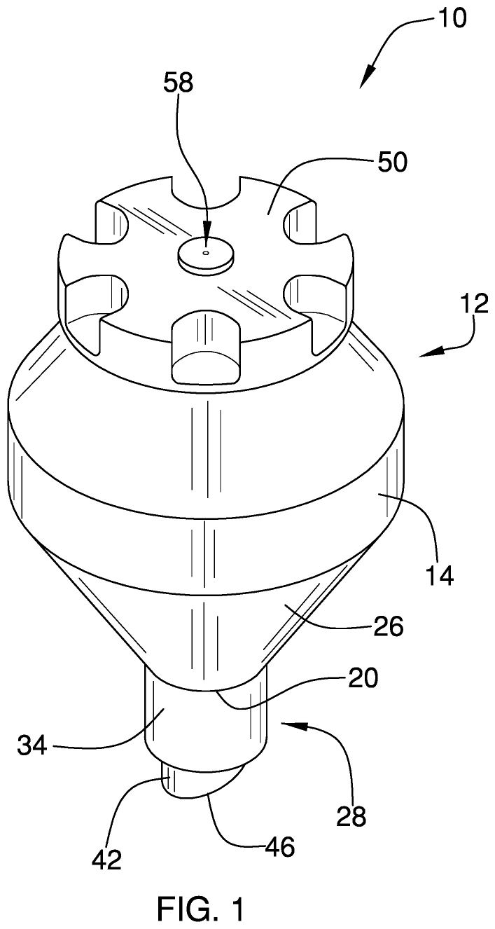

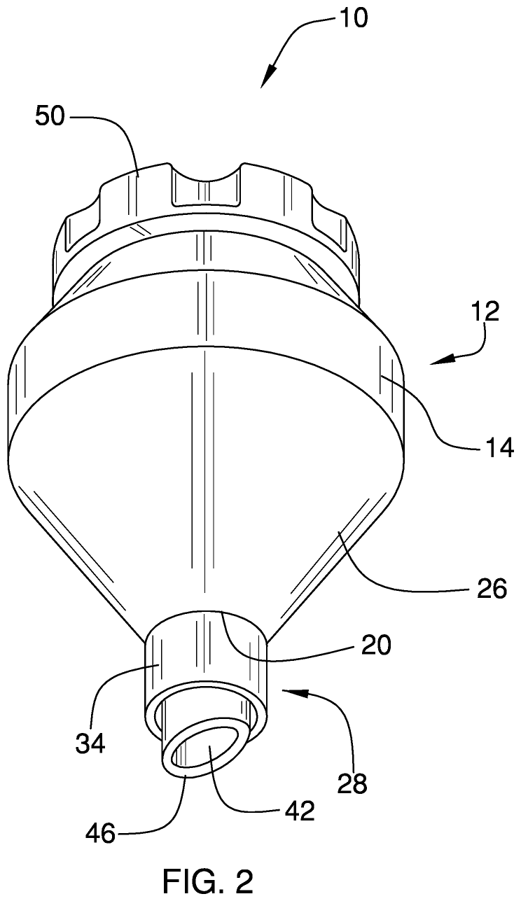

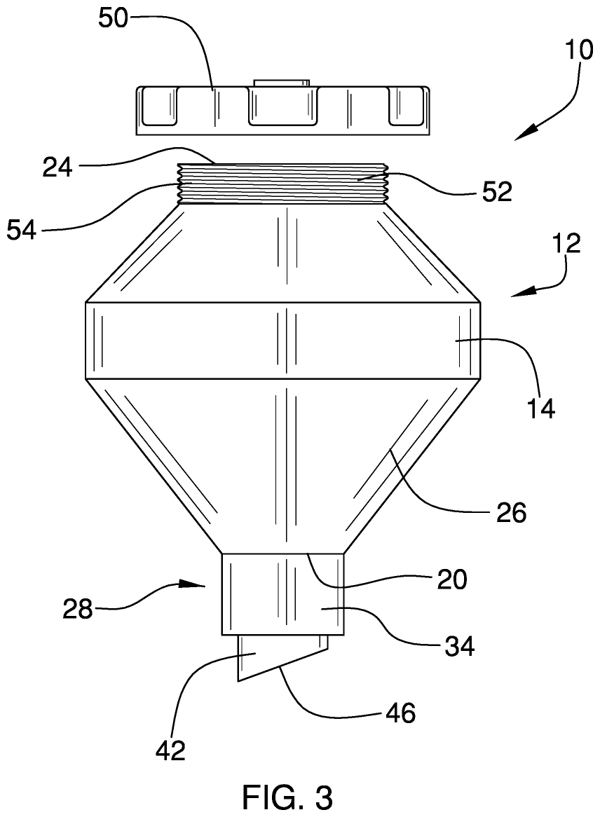

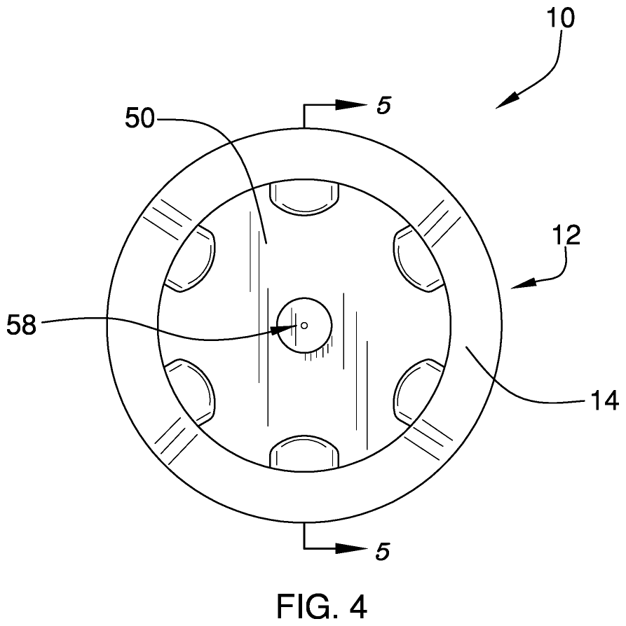

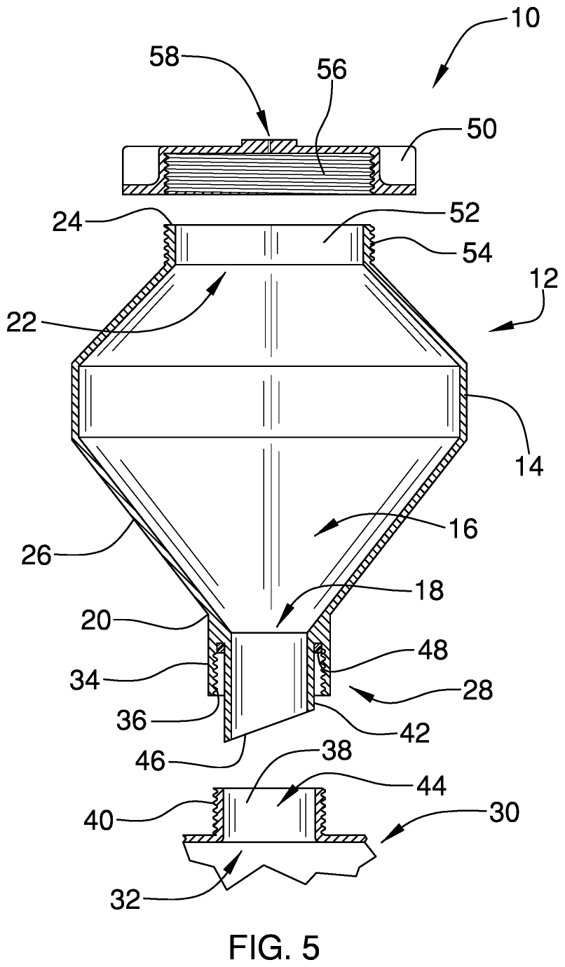

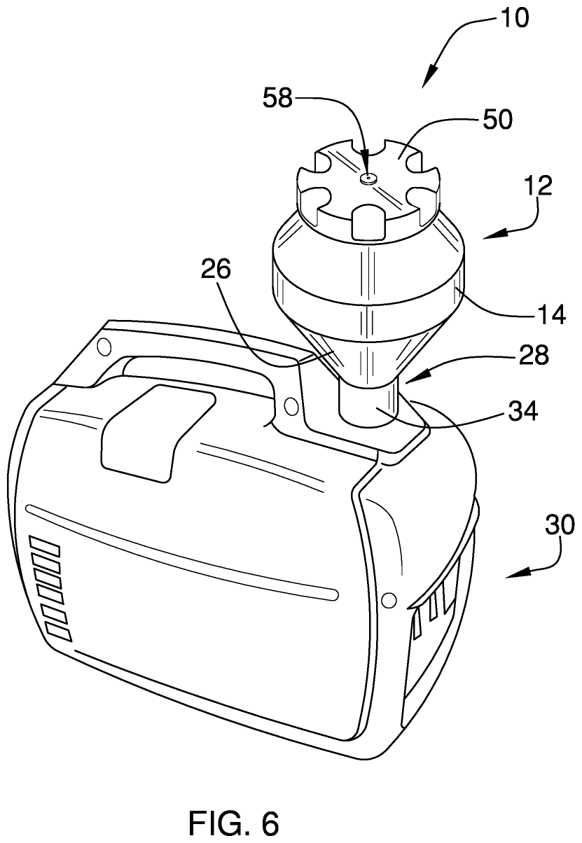

With reference now to the drawings, and in particular to FIGS. 1 through 6 thereof, a new fuel filling apparatus embodying the principles and concepts of an embodiment of the disclosure and generally designated by the reference numeral 10 will be described.

As best illustrated in FIGS. 1 through 6, the fuel reservoir apparatus 10 generally comprises a container 12 having a perimeter wall 14 which bounds a chamber 16 for retaining auxiliary fuel. The container 12 has an outlet 18 to the chamber 16 which is positioned at a bottom end 20 thereof and an inlet 22 which is positioned at a top end 24 thereof. The perimeter wall 14 has a funnel portion 26 which is shaped such that the chamber 16 narrows downwardly along the funnel portion 26 to the bottom end 20 of the container 12. A width of the inlet 22 is greater than a width of the outlet 18 and is at least 4.0 inches. A connector 28 is coupled to the container 12 and is configured to fluidly couple the chamber 16 to a tank 32 of an electric generator 30 through the outlet 18. The connector 28 comprises a female member 34 with internal threads 36 configured to be complementary in shape to external threads 40 of a male member 38 of the electric generator 30.

A discharge spout 42 is coupled to the bottom end 20 of the container 12 and is in fluid communication with the chamber 16. The discharge spout 42 extends downwardly from the bottom end 20 and has a size such that the discharge spout 42 is configured to be insertable into a bore 44 in the male member 38 of the electric generator 30 to fluidly couple to the tank 32 of the electric generator 30. A distal end 46 of the discharge spout 42 with respect to the container 12 is angled such that a width of the discharge spout 42 taken perpendicular to a vertical line extending through the discharge spout 42 decreases downwardly along the vertical line away from the container 12, and the distal end 46 of the discharge spout 42 thus facilitates insertion of the discharge spout 42 into the bore 44 of the male member 38 of the electric generator 30. The discharge spout 42 is positioned in the female member 34 of the connector 28. A gasket 48 is mounted to the connector 28 and is positioned to form a seal with the electric generator 30 when the chamber 16 is fluidly coupled to the tank 32. The gasket 48 extends around the discharge spout 42.

A lid 50 is removably attached to the top end 24 of the container 12 to close the inlet 22. The lid 50 is threadably coupled to the container 12. The container 12 has a neck 52 at the top end 24 thereof with exterior threads 54 which are complementary in shape to interior threads 56 of the lid 50. The lid 50 has a vent hole 58 which extends therethrough for allowing air into the chamber 16 through the inlet 22 when the lid 50 is attached to the top end 24.

In use, the discharge spout 42 is inserted into the bore 44 of the male member 38 of the electric generator 30, and the container 12 is connected to the male member 38 via the connector 28. Fuel is poured into the chamber 16 through the inlet 22, which is directed by the funnel portion 26 of the container 12 into the tank 32 of the electric generator 30. After the tank 32 becomes full of fuel, the fuel continues to be poured into the chamber 16 to fill the chamber 16 with auxiliary fuel. This expands the capacity of the tank 32 of the electric generator 30. The inlet 22 is wider than the outlet 18 so that the level of fuel in the chamber 16 is unobstructed from view, facilitating a user to be able to substantially fill the chamber 16 with less risk of overflowing the chamber 16. After filling, the lid 50 is attached to the container 12 so that fuel does not spill out and so that air may be let in through the vent hole 58 when the electric generator 30 is in use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A fuel reservoir apparatus to facilitate filling a fuel tank of an electric generator and to retain auxiliary fuel for the electric generator, the apparatus comprising:
a container comprising a perimeter wall which bounds a chamber for retaining the auxiliary fuel, the container having an outlet to the chamber being positioned at a bottom end thereof, the container having an inlet to the chamber being positioned at a top end thereof, the perimeter wall having a funnel portion, an upper portion, and a middle portion, the middle portion being coupled to an extending between the upper portion and the funnel portion, the funnel portion being shaped such that the chamber narrows downwardly along the funnel portion to a bottom end of the container, the upper portion tapering from the middle portion toward the top end;
a connector being coupled to the container and being configured to fluidly couple the chamber to the tank of the electric generator through the outlet; and
a lid being removably attached to the top end of the container to close the inlet, the lid having a width less than a width of the middle portion of the perimeter wall of the container.

2. (canceled)

3. The apparatus of claim 1, wherein a width of the inlet is greater than a width of the outlet.

4. The apparatus of claim 3, wherein the width of the inlet is at least 4.0 inches.

5. The apparatus of claim 1, wherein the connector comprises a female member having internal threads configured to be complementary in shape to external threads of a male member of the electric generator.

6. The apparatus of claim 5, further comprising a discharge spout being coupled to a bottom end of the container and being in fluid communication with the chamber, the discharge spout extending downwardly from the bottom end, the discharge spout having a size such that the discharge spout is configured to be insertable into a bore in the male member of the electric generator to fluidly couple to the tank of the electric generator.

7. The apparatus of claim 6, wherein a distal end of the discharge spout with respect to the container is angled such that a width of the discharge spout taken perpendicular to a vertical line extending through the discharge spout decreases downwardly along the vertical line away from the container, the distal end of the discharge spout facilitating insertion of the discharge spout into the bore of the male member of the electric generator.

8. The apparatus of claim 6, wherein the connector comprises a female member having internal threads configured to be complementary in shape to external threads of a male member of the electric generator, the discharge spout being positioned in the female member of the connector.

9. The apparatus of claim 1, further comprising a gasket being mounted to the connector and being positioned to form a seal with the electric generator when the chamber is fluidly coupled to the tank.

10. The apparatus of claim 8, further comprising a gasket being mounted to the connector and being positioned to form a seal with the electric generator when the chamber is fluidly coupled to the tank, the gasket extending around the discharge spout.

11. (canceled)

12. The apparatus of claim 1, wherein the lid is threadably coupled to the container.

13. The apparatus of claim 12, wherein the container has a neck at the top end thereof having exterior threads which are complementary in shape to interior threads of the lid.

14. The apparatus of claim 1, wherein the lid has a vent hole extending therethrough for allowing air into the chamber through the inlet when the lid is attached to the top end.

15. A fuel reservoir apparatus to facilitate filling a fuel tank of an electric generator and to retain auxiliary fuel for the electric generator, the apparatus comprising:
a container comprising a perimeter wall which bounds a chamber for retaining the auxiliary fuel, the container having an outlet to the chamber being positioned at a bottom end thereof, the container having an inlet to the chamber being positioned at a top end thereof, the perimeter wall having a funnel portion, an upper portion, and a middle portion, the middle portion being coupled to an extending between the upper portion and the funnel portion, the funnel portion being which is shaped such that the chamber narrows downwardly along the funnel portion to a bottom end of the container, the upper portion tapering from the middle portion toward the top end, a width of the inlet being greater than a width of the outlet, the width of the inlet being at least 4.0 inches;
a connector being coupled to the container and being configured to fluidly couple the chamber to the tank of the electric generator through the outlet, the connector comprising a female member having internal threads configured to be complementary in shape to external threads of a male member of the electric generator;
a discharge spout being coupled to the bottom end of the container and being in fluid communication with the chamber, the discharge spout extending downwardly from the bottom end, the discharge spout having a size such that the discharge spout is configured to be insertable into a bore in the male member of the electric generator to fluidly couple to the tank of the electric generator, a distal end of the discharge spout with respect to the container being angled such that a width of the discharge spout taken perpendicular to a vertical line extending through the discharge spout decreases downwardly along the vertical line away from the container, the distal end of the discharge spout facilitating insertion of the discharge spout into the bore of the male member of the electric generator, the discharge spout being positioned in the female member of the connector;
a gasket being mounted to the connector and being positioned to form a seal with the electric generator when the chamber is fluidly coupled to the tank, the gasket extending around the discharge spout; and
a lid being removably attached to the top end of the container to close the inlet, the lid being threadably coupled to the container, the container having a neck at the top end thereof having exterior threads which are complementary in shape to interior threads of the lid, the lid having a vent hole extending therethrough for allowing air into the chamber through the inlet when the lid is attached to the top end, the lid having a width less than a width of the middle portion of the perimeter wall of the container.
